(19) United States
(12) Patent Application Publication
(10) Pub. No.: US 2026/0027978 A1
(43) Pub. Date: Jan. 29, 2026

(54) Car Seat Attachable Speaker Device

(71) Applicant: Aja Jordan, Lakewood Ranch, FL (US)

(72) Inventor: Aja Jordan, Lakewood Ranch, FL (US)

(21) Appl. No.: 18/893,381

(22) Filed: Sep. 23, 2024

Related U.S. Application Data
(60) Provisional application No. 63/674,320, filed on Jul. 23, 2024.

(51) Int. Cl. B60R 11/02; B60Q 3/233; B60R 11/00

(52) U.S. Cl. CPC B60R 11/0217; B60Q 3/233; B60R 2011/0012; B60R 2011/0059

(57) ABSTRACT

A car seat attachable speaker device is provided comprised of a body that can be shaped to appeal to infants, incorporating at least one speaker and a wireless transmitter to allow the speaker to connect with a smart device. The speakers are designed to direct sound towards the child, minimizing disturbance to other vehicle occupants, and can be controlled via buttons on the device. The device is powered by a battery and wherein the device can be attached to various parts of a vehicle near the child's seat using adjustable fasteners. Additionally, the device may feature a light for illumination and a motion sensor that pauses audio when the child is inactive, such as when sleeping. The invention also includes a method for using the device, which involves attaching it to a vehicle, pairing it with a smart device, and playing audio specifically directed at the child.

### CROSS-REFERENCE TO RELATED APPLICATION

The present application claims priority to, and the benefit of, U.S. Provisional Application No. 63/674,320, which was filed on Jul. 23, 2024, and is incorporated herein by reference in its entirety.

### FIELD OF THE INVENTION

The present invention relates generally to the field of audio-playing devices. More specifically, the present invention relates to a car seat attachable speaker device that can be attached to an infant's car seat and wirelessly paired to a smart device in order to play audio towards an infant without the need to play said audio through the audio system of the vehicle the child is within. Accordingly, the present disclosure makes specific reference thereto. Nonetheless, it is to be appreciated that aspects of the present invention are also equally applicable to other like applications, devices, and methods of manufacture.

### BACKGROUND

Young children often experience anxiety and discomfort during car rides, particularly when they are not sufficiently entertained or occupied. This restlessness can lead to distress for both the child and the other passengers in the vehicle. To mitigate this, parents or caregivers may opt to play music, audiobooks, or television shows for the child to listen to and watch during the journey. However, this solution can introduce its own set of challenges.

For instance, when the child's audio is played through the vehicle's sound system, it forces all occupants to listen to the same content, which may not be to everyone's liking. This situation can become especially frustrating if the other passengers prefer to listen to different audio, such as their own music, or a podcast, or simply enjoy some quiet time. The lack of choice in speaker can lead to discomfort and dissatisfaction among the other passengers, making the car ride less enjoyable for everyone.

Moreover, while using a smart device like a phone or tablet to play audio directly for the child may seem like a convenient alternative, it often presents its own set of issues. One common problem is that the speakers on these devices may not be powerful enough to project sound at a level that is clearly audible to the child, particularly in a noisy car environment. Additionally, these devices are frequently positioned at a distance from the child, perhaps mounted on a seatback or held by another passenger which further diminishes the audio quality and volume. As a result, the child may have difficulty hearing the content, leading to frustration and a lack of engagement with the intended speaker.

Consequently, the combination of these factors, the inability to clearly hear the audio and the limitations imposed on other passengers' listening preferences can result in a more stressful and uncomfortable car ride for everyone involved.

Therefore, there exists a long-felt need in the art for an improved audio playback device for use with children during a car ride. There also exists a long-felt need in the art for a car seat attachable speaker device. Further, there exists a long-felt need in the art for a car seat attachable speaker device that provides improved audio to a child seated in a car seat. More specifically, there exists a long-felt need in the art for a car seat attachable speaker device that provides improved audio to a child seated in a car seat via increased proximity of the device to a child and also an adjustable volume level of the device. Finally, there exists a long-felt need in the art for a car seat attachable speaker device that provides improved audio to a child seated in a car seat via increased proximity of the device to a child and also an adjustable volume level of the device, wherein the device does not force audio directed toward the child to be played through the audio system of a vehicle the child is within.

The subject matter disclosed and claimed herein, in one embodiment thereof, comprises a car seat attachable speaker device. The device is comprised of a body that can be shaped and decorated to appeal to infants, incorporating at least one speaker and a wireless transmitter to allow the speaker to connect with a smart device. The speakers are designed to direct sound towards the child, minimizing disturbance to other vehicle occupants, and can be controlled via buttons on the device. The device is powered by a battery and wherein the device can be attached to various parts of a vehicle near the child's seat using adjustable fasteners. Additionally, the device may feature a light for illumination and a motion sensor that pauses audio when the child is inactive, such as when sleeping. The invention also includes a method for using the device, which involves attaching it to a vehicle, pairing it with a smart device, and playing audio specifically directed at the child.

In this manner, the car seat attachable speaker device of the present invention accomplishes all the foregoing objectives and provides an improved audio playback device for use with children during a car ride. More specifically, the device provides improved audio to a child seated in a car seat via increased proximity of the device to a child and also an adjustable volume level of the device. Further, the device does not force audio directed toward the child to be played through the audio system of a vehicle the child is within during use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car seat attachable speaker device comprised of a body comprised of at least one speaker, at least one transmitter, and at least one adjustment fastener. The device is comprised of a body that may be shaped as things such as, but not limited to, an animal, a character, a person, an object, an item, a food, a toy, etc., in order to make the body visually appealing to an infant during use. In one embodiment, the body may further be comprised of at least one indicia such as, but not limited to, a pattern, a design, an image, a facial feature, etc., that may relate to the shape and/or theme of the body.

The body is comprised of at least one speaker comprised of at least one transmitter. The transmitter is preferably a wireless Bluetooth transmitter that allows the speaker to be placed in wireless electrical communication with a smart device such as, but not limited to, a cell phone or a tablet. As a result, audio from the smart device can be played from the speaker and need not be played from the audio system of the vehicle the child is in, allowing a driver/other passengers to listen to separate audio. A volume level of the speakers and/or the power level (i.e., on or off) of the speakers may be controlled via at least one button on the body. The speaker and transmitter are powered by at least one battery. In a non-removable and rechargeable embodiment, the battery can be recharged via at least one charging port.

During use, the device can be attached to a plurality of locations near a child when a child is seated in a car seat. These areas may include, but are not limited to, any portion of the car seat, passenger seat headrest, seatbelt, etc. To attach in this manner, the body is comprised of at least one fastener. In the preferred embodiment, the fastener is comprised of an elastic band. However, the fastener may be a non-elastic band in one embodiment comprised of an adjustment fastener that allows a length of the fastener to be adjusted as needed. In this embodiment, the fastener may be comprised of a secondary fastener that allows the fastener to remain secure, such as, but not limited to, a buckle, a snap button, a hook and loop fastener, etc.

The present invention is also comprised of a method of using the device. First, a device is provided comprised of a body comprised of at least one speaker, at least one wireless transmitter, and at least one fastener. Then, the body can be attached to a car seat, seatbelt, or other area within a vehicle near a child sitting in a car seat. Next, the speaker can be wirelessly paired with Bluetooth to a smart device by pressing a pairing button. Finally, audio can be selected from the smart device, wherein the audio is then played towards the child via the speaker.

Accordingly, the car seat attachable speaker device of the present invention is particularly advantageous as it provides an improved audio playback device for use with children during a car ride. More specifically, the device provides improved audio to a child seated in a car seat via increased proximity of the device to a child and also an adjustable volume level of the device. Further, the device does not force audio directed toward the child to be played through the audio system of a vehicle the child is within during use. In this manner, the car seat attachable speaker device overcomes the limitations of existing devices and methods used to play audio to a child seated in a car seat within a vehicle known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a car seat attachable speaker device of the present invention in accordance with the disclosed architecture;

FIG. 2 illustrates a perspective view of one potential embodiment of a car seat attachable speaker device of the present invention in accordance with the disclosed architecture;

FIG. 3 illustrates a perspective view of one potential embodiment of a car seat attachable speaker device of the present invention in accordance with the disclosed architecture;

FIG. 4 illustrates a flowchart of a method of using one potential embodiment of a car seat attachable speaker device of the present invention in accordance with the disclosed architecture; and

FIG. 5 illustrates a perspective view of one potential embodiment of a car seat attachable speaker device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved audio playback device for use with children during a car ride. There also exists a long-felt need in the art for a car seat attachable speaker device. Further, there exists a long-felt need in the art for a car seat attachable speaker device that provides improved audio to a child seated in a car seat. More specifically, there exists a long-felt need in the art for a car seat attachable speaker device that provides improved audio to a child seated in a car seat via increased proximity of the device to a child and also an adjustable volume level of the device. Finally, there exists a long-felt need in the art for a car seat attachable speaker device that provides improved audio to a child seated in a car seat via increased proximity of the device to a child and also an adjustable volume level of the device, wherein the device does not force audio directed toward the child to be played through the audio system of a vehicle the child is within.

The present invention, in one exemplary embodiment, is comprised of a car seat attachable speaker device comprised of a body comprised of at least one speaker, at least one transmitter, and at least one adjustment fastener. The device is comprised of a body that may be shaped as things such as, but not limited to, an animal, a character, a person, an object, an item, a food, a toy, etc., in order to make the body visually appealing to an infant during use. In one embodiment, the body may further be comprised of at least one indicia such as, but not limited to, a pattern, a design, an image, a facial feature, etc., that may relate to the shape and/or theme of the body.

The body is comprised of at least one speaker comprised of at least one transmitter that is preferably a wireless Bluetooth transmitter that allows the speaker to be placed in wireless electrical communication with a smart device such as, but not limited to, a cell phone or a tablet. As a result, audio from the smart device can be played from the speaker and need not be played from the audio system of the vehicle the child is in, allowing a driver/other passengers to listen to separate audio. A volume level of the speakers and/or the power level (i.e., on or off) of the speakers may be controlled via at least one button on the body. The speaker and transmitter are powered by at least one battery. In a non-removable and rechargeable embodiment, the battery can be recharged via at least one charging port.

During use, the device can be attached to a plurality of locations near a child when a child is seated in a car seat. These areas may include, but are not limited to, any portion of the car seat, passenger seat headrest, seatbelt, etc. To attach in this manner, the body is comprised of at least one fastener preferably comprised of an elastic band. However, the fastener may be a non-elastic band in one embodiment comprised of an adjustment fastener that allows a length of the fastener to be adjusted as needed. In this embodiment, the fastener may be comprised of a secondary fastener that allows the fastener to remain secure, such as, but not limited to, a buckle, a snap button, a hook and loop fastener, etc.

The present invention is also comprised of a method of using the device. First, a device is provided comprised of a body comprised of at least one speaker, at least one wireless transmitter, and at least one fastener. Then, the body can be attached to a car seat, seatbelt, or other area within a vehicle near a child sitting in a car seat. Next, the speaker can be wirelessly paired with Bluetooth to a smart device by pressing a pairing button. Finally, audio can be selected from the smart device, wherein the audio is then played towards the child via the speaker.

Accordingly, the car seat attachable speaker device of the present invention is particularly advantageous as it provides an improved audio playback device for use with children during a car ride. More specifically, the device provides improved audio to a child seated in a car seat via increased proximity of the device to a child and also an adjustable volume level of the device. Further, the device does not force audio directed toward the child to be played through the audio system of a vehicle the child is within during use. In this manner, the car seat attachable speaker device overcomes the limitations of existing devices and methods used to play audio to a child seated in a car seat within a vehicle known in the art.

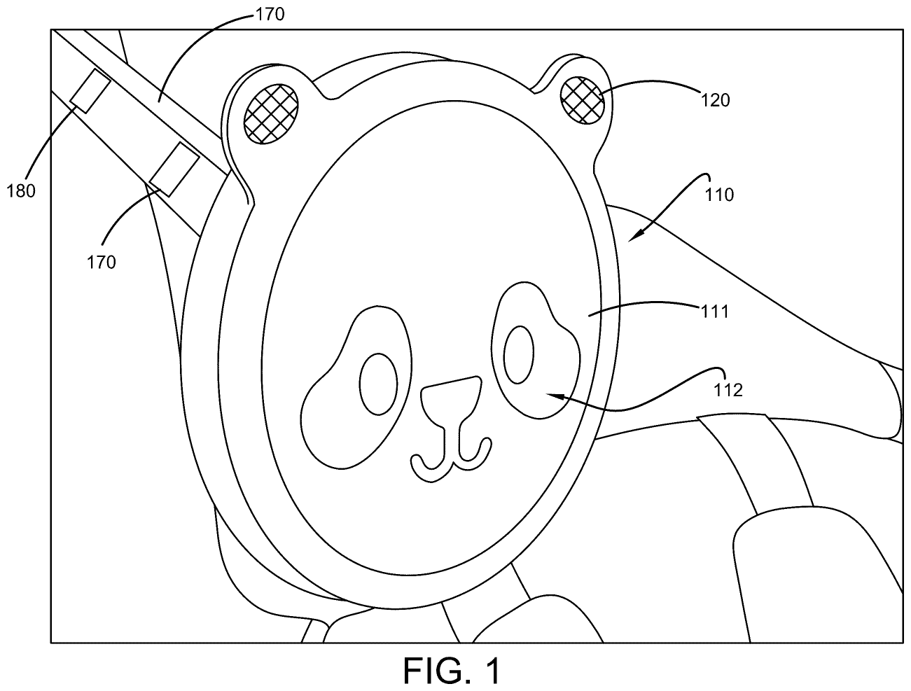

Referring initially to the drawings, FIG. 1 illustrates a perspective view of one potential embodiment of a car seat attachable speaker device 100 of the present invention in accordance with the disclosed architecture. The device 100 is comprised of a body 110 comprised of at least one speaker 120, at least one transmitter 150, and at least one adjustment fastener 180. The device 100 is comprised of a body 110. The body 110 may be any shape in different embodiments. This includes a shape that is simulative of things such as, but not limited to, an animal, a character, a person, an object, an item, a food, a toy, etc., in order to make the body 110 visually appealing to an infant during use. In one embodiment, the body 110 may further be comprised of at least one indicia 112 such as, but not limited to, a pattern, a design, an image, a facial feature, etc., that may relate to the shape and/or theme of the body 110. In one embodiment, the body 110 is comprised of a removable decorative cover 113 that allows a user to change the appearance of the body 110.

The body 110 is comprised of at least one speaker 120. The speaker 120 may be any shape, size, and configuration of the speaker. The speaker 120 is preferably comprised of at least one transmitter 150. The transmitter 150 is preferably a wireless Bluetooth transmitter that allows the speaker to be placed in wireless electrical communication with a smart device such as, but not limited to, a cell phone 14 or a tablet. As a result, audio from the smart device can be played from the speaker 120 and need not be played from the audio system of the vehicle the child is in, allowing a driver/other passengers to listen to separate audio. A volume level of the speakers 120 and/or the power level (i.e., on or off) of the speakers 120 may be controlled via at least one button 160 on the body 110. In one embodiment, the speakers 120 may be angled relative to a front surface 111 of the body 110. As a result, the speakers 120 direct sound specifically and directly towards a child, therefore limiting exposure of the audio to other occupants of the vehicle. In an embodiment with non-angled speakers 120, this effect could also be achieved via the positioning of the device 100 (i.e., wherein the front surface 111 faces a child).

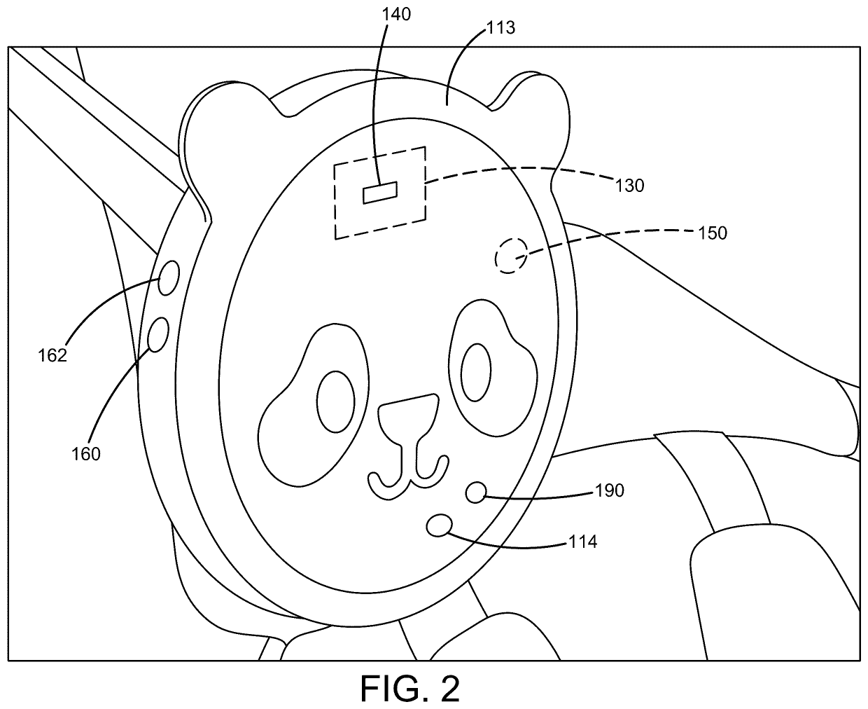

The speaker 120 and transmitter 150 are powered by at least one battery 130, as seen in FIG. 2. The battery 130 may be removable or non-removable and rechargeable or non-rechargeable in different embodiments. In a non-removable and rechargeable embodiment, the battery 130 can be recharged via at least one charging port 140. The charging port 140 may be any configuration of charging port, such as, but not limited to, a USB charging port.

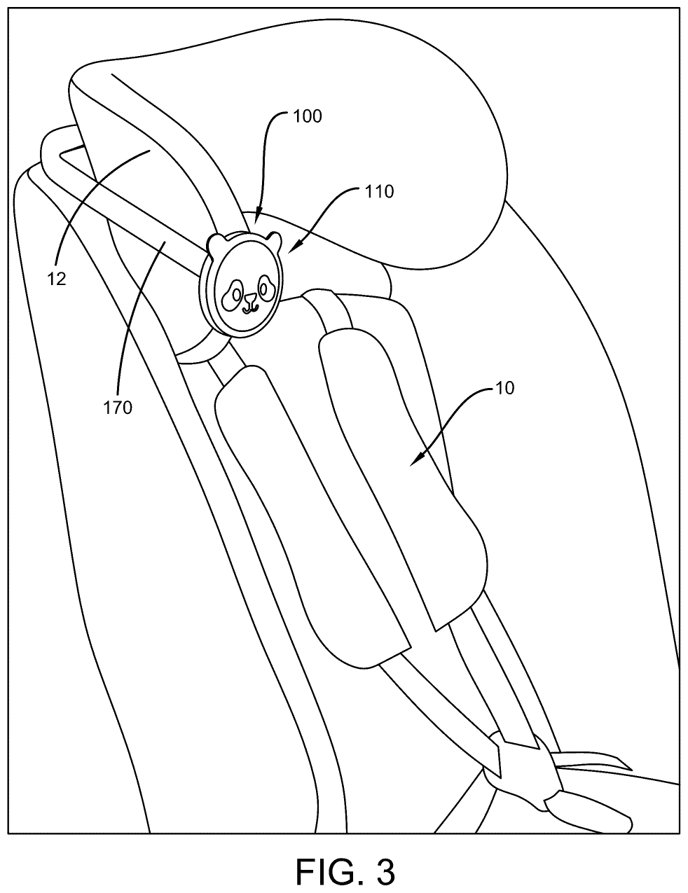

During use, the device 100 can be attached to a plurality of locations near a child when a child is seated in a car seat 10. These areas may include, but are not limited to, any portion of the car seat 10, passenger seat headrest, seatbelt, etc. To attach in this manner, the body 110 is comprised of at least one fastener 170, as seen in FIG. 3. In the preferred embodiment, the fastener 170 is comprised of an elastic band. However, the fastener 170 may be a non-elastic band in one embodiment. In this embodiment, the fastener 170 is comprised of an adjustment fastener 180, such as, but not limited to, a sliding buckle 180, that allows a length of the fastener 170 to be adjusted as needed. In this embodiment, the fastener 170 may be comprised of a secondary fastener 170 that allows the fastener 170 to remain secure, such as, but not limited to, a buckle, a snap button, a hook and loop fastener, etc.

In one embodiment, the body 110 is comprised of at least one light 114. The light 114 may be repositionable in one embodiment. As a result, the light 114 can be used to illuminate the area in front of a child if the child is performing an activity in the car seat 10. A brightness level and a power level (i.e., on/off) of the light 114 may be controlled by at least one button 160. In one embodiment, the device 100 is comprised of a motion sensor 190 that automatically pauses audio from the speaker 120 if motion of the child in the car seat 10 is not detected for a period of time (i.e., when the child is asleep).

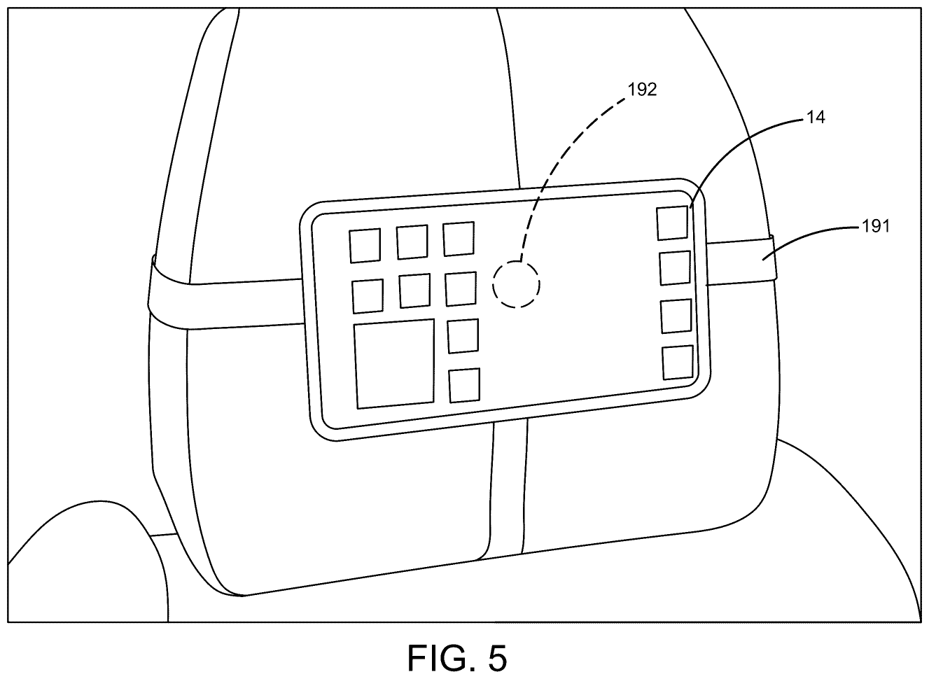

In one embodiment, as seen in FIG. 5, the device 100 is comprised of at least one fastener 191. The fastener 191 attaches to a vehicle headrest to allow a phone 14 to be viewed from a user sitting in a car seat. The fastener 191 is preferably a strap that may be adjustable or non-adjustable. The strap may be an elastic strap or any other strap such as but not limited to a hook and loop strap, a snap button strap, etc. The fastener 191 may attach directly to a phoner 14 via at least one secondary fastener 192. The secondary fastener 192 may include but is not limited to a magnet, a loop, a clip, a clamp, or any similar fastener of the like that can removably receive a cell phone, tablet, or other smart device of the like.

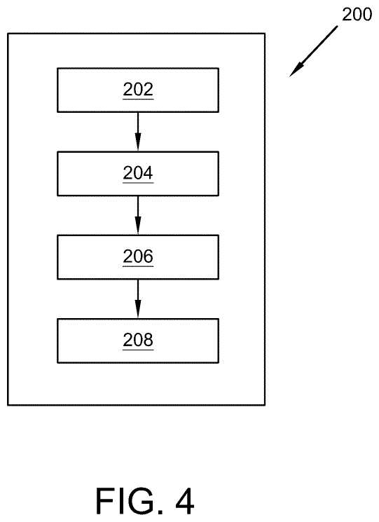

The present invention is also comprised of a method of using 200 the device 100, as seen in FIG. 4. First, a device 100 is provided comprised of a body 110 comprised of at least one speaker 120, at least one wireless transmitter 150, and at least one fastener 170 [Step 202]. Then, the body 110 can be attached to a car seat 10, seatbelt, or other area within a vehicle near a child sitting in a car seat 10 [Step 204]. Next, the speaker 120 can be wirelessly paired with Bluetooth to a smart device by pressing a pairing button 162 [Step 206]. Finally, audio can be selected from the smart device, wherein the audio is then played towards the child via the speaker 120 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “car seat attachable speaker device” and “device” are interchangeable and refer to the car seat attachable speaker device 100 of the present invention.

Notwithstanding the foregoing, the car seat attachable speaker device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the car seat attachable speaker device 100 as shown in the FIGS. are for illustrative purposes only, and that many other sizes and shapes of the car seat attachable speaker device 100 are well within the scope of the present disclosure. Although the dimensions of the car seat attachable speaker device 100 are important design parameters for user convenience, the car seat attachable speaker device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A car seat attachable speaker device comprising:
a body comprised of:
a speaker;
a transmitter;
a battery;
a button; and
a fastener.

2. The car seat attachable speaker device of claim 1, wherein the body is comprised of a shape of an animal, a character, a person, an object, an item, a food, or a toy.

3. The car seat attachable speaker device of claim 1, wherein the body is comprised of an indicia.

4. The car seat attachable speaker device of claim 3, wherein the indicia is comprised of a pattern, a design, an image, or a facial feature.

5. The car seat attachable speaker device of claim 1, wherein the transmitter is comprised of a Bluetooth transmitter.

6. The car seat attachable speaker device of claim 1, wherein a volume level of the speaker can be controlled by the button.

7. The car seat attachable speaker device of claim 1, wherein the battery is removable.

8. The car seat attachable speaker device of claim 1, wherein the fastener is comprised of an elastic band.

9. A car seat attachable speaker device comprising:
a body comprised of:
a speaker;
a transmitter;
a battery;
a button; and
a fastener.

10. The car seat attachable speaker device of claim 9, wherein the speaker is comprised of an angled speaker that is angled relative to a front surface of the body.

11. The car seat attachable speaker device of claim 9, wherein the battery is comprised of a non-removable and a rechargeable battery.

12. The car seat attachable speaker device of claim 10, wherein the battery can be recharged via a charging port of the body.

13. The car seat attachable speaker device of claim 9, wherein the fastener is comprised of an adjustable-length strap.

14. The car seat attachable speaker device of claim 13, wherein the fastener is comprised of a sliding buckle that allows for a length of the adjustable-length strap to be adjusted.

15. The car seat attachable speaker device of claim 13, wherein the fastener is comprised of a secondary fastener.

16. The car seat attachable speaker device of claim 15, wherein the secondary fastener is comprised of a buckle, a snap button, or a hook and loop fastener.

17. The car seat attachable speaker device of claim 9, wherein the body is comprised of a light.

18. The car seat attachable speaker device of claim 17, wherein the light is comprised of a repositionable light.

19. The car seat attachable speaker device of claim 9, wherein the body is comprised of a removable decorative cover.

20. A method of using a car seat attachable speaker device, the method comprising the following steps:
providing a car seat attachable speaker device comprised of a speaker, a wireless transmitter, and a fastener;
attaching the body to a car seat a child is sitting in;
pairing the speaker wirelessly with a smart device; and
selecting an audio from the smart device that is played towards the child via the speaker.
